(19) United States
(12) Patent Application Publication
(10) Pub. No.: US 2009/0236182 A1
(43) Pub. Date: Sep. 24, 2009

(54) FUEL CELL INDUSTRIAL VEHICLE

(76) Inventor: Tomohiro YAMAGAMI, Kariya-shi (JP)

Correspondence Address: Locke Lord Bissell & Liddell LLP;Attn: IP Docketing, Three World Financial Center, New York, NY, 10281-2101, US

(21) Appl. No.: 12/407,969

(22) Filed: Mar. 20, 2009

(30) Foreign Application Priority Data
Mar. 21, 2008 (JP) 2008-073954

(51) Int. Cl. B66F 9/075; B66F 9/06

(52) U.S. Cl. 187/222

(57) ABSTRACT

A fuel cell forklift using a fuel cell unit, which includes a fuel cell system and which is replaceable by a lead-acid battery. The forklift includes a motor which generates drive force when supplied with power from the fuel cell unit or lead-acid battery. A voltmeter measures voltage of the fuel cell unit or lead-acid battery. A vehicle controller controls operation of the forklift and restricts operation when the measured voltage is less than a threshold voltage. The fuel cell unit includes a capacitor charged by the fuel cell system. A voltage conversion unit converts voltage of power from the capacitor to a target voltage, which is set to be greater than or equal to the threshold voltage, and supplies a power supply destination, which includes the motor, with the power of which voltage has been converted to the target voltage.

### BACKGROUND OF THE INVENTION

The present invention relates to a fuel cell powered industrial vehicle that uses a fuel cell unit, which is replaceable by a lead-acid battery, as a power supply for supplying power to a motor of the industrial vehicle.

Nowadays, fuel cells, which are clean and have high energy efficiency, are looked upon as a power supply applicable to vehicles, such as an industrial vehicle. As known in the art, a fuel cell produces electromotive force from chemical reactions which occur between hydrogen and oxygen. Japanese Laid-Open Patent Publication No. 2003-70106 suggests an automotive capacitor system that uses a fuel cell. The capacitor system includes an electric double-layer capacitor, which serves as a main capacitor, and a fuel cell system, which serves as an auxiliary power generator that compensates for the low energy density of the electric double-layer capacitor. In the system described in the publication, the electric double-layer capacitor is rechargeable by a dynamo, which is connected to the engine of a vehicle, and a generator, which is connected to the drive wheels of the vehicle to generate regenerative power. The electric double-layer capacitor discharges the charged power when required. When the electric double-layer capacitor cannot supply a load with sufficient power, the fuel cell system generates power to compensate for the insufficient amount. A converter converts the power supplied from the electric double-layer capacitor to a predetermined voltage that is required for driving the load such as a motor.

FIG. 3 shows a fuel cell forklift. The forklift is of a so-called “battery replacement type,” in which a fuel cell unit FU is replaceable with a lead-acid battery B in a battery compartment 52. Generally, a lead-acid battery or an electric double-layer capacitor is used as a rechargeable battery for the fuel cell unit FU. FIG. 4A shows the relationship between the discharge amount and voltage when using a lead-acid battery as a rechargeable battery. As apparent from FIG. 4A, the voltage first maintains a generally constant value but then suddenly decreases when the discharged amount reaches a predetermined value. FIG. 4B shows the relationship between the discharge amount and voltage when using an electric double-layer capacitor as a rechargeable battery. As apparent from FIG. 4B, the decrease in voltage is in substantial proportion to the increase in the discharged amount.

The forklift 51 includes a lead-acid battery capacitance meter (voltmeter) for measuring the voltage of the lead-acid battery B to determine the discharged amount of the lead-acid battery B. Referring to FIGS. 4A and 4B, when the voltage measured by the capacitance meter becomes less than a predetermined threshold voltage Vk, that is, when the discharged amount of the lead-acid battery B becomes greater than a predetermined discharged amount, a predetermined warning (notification) is issued in the forklift 51 or restrictions are imposed on the operation of the forklift 51. This prompts the user of the forklift 51 to perform charging. The threshold voltage Vk is a predetermined value based on a tolerable limit discharged amount of the lead-acid battery B. When discharged such that the voltage becomes less than the threshold voltage Vk, the lead-acid battery B may be adversely affected.

In a battery replacement type fuel cell forklift, the capacitance meter and controller are employed under the assumption that a lead-acid battery B would be used. In other words, the fuel cell unit FU is replaceable with the lead-acid battery B without the necessity for replacement of components and large-scale modifications in conventional forklifts. This is advantageous in that a conventional battery forklift may be converted into a fuel cell forklift. However, this also has shortcomings. For example, when using the fuel cell unit FU, which includes an electric double-layer capacitor serving as a rechargeable battery, if the stored charge becomes low due to self-discharge, the voltage has a tendency of becoming low because of the characteristics of the electric double-layer capacitor. Further, when the voltage measured by the capacitance meter, which is employed under the assumption that the lead-acid battery B would be used, becomes less than the threshold voltage Vk, which is also set under the assumption that the lead-acid battery B would be installed, it is determined that “the discharge amount of the installed lead-acid battery is large (i.e., voltage is low)” in the forklift 51. As a result, a warning may be issued and operations may be restricted as described above. Such warning and operation restrictions would protect the lead-acid battery B from adverse effects. Thus, such warning (notification) and operation restrictions are not cancelled unless the fuel cell unit FU supplies power so that the capacitor voltage becomes equal to the threshold voltage Vk or greater. For this reason, once a warning is issued or an operation is limited, much time is required for recovery from such a state.

### SUMMARY OF THE INVENTION

It is an object of the present invention to provide a fuel cell industrial vehicle that uses a fuel cell unit replaceable by a lead-acid battery, in which operation of the industrial vehicle is not restricted even when the voltage of the power from a fuel cell unit becomes low.

One aspect of the present invention is an industrial vehicle optionally powerable by a lead-acid battery. The industrial vehicle includes a fuel cell unit. A motor generates drive force when supplied with power from the fuel cell unit or the lead-acid battery. A voltmeter measures voltage of the fuel cell unit or voltage of the lead-acid battery. A vehicle control unit controls operation of the industrial vehicle and restricts operation of the industrial vehicle when the voltage measured by the voltmeter is less than a predetermined threshold voltage. The fuel cell unit includes a capacitor and a voltage conversion unit. The capacitor is chargeable by power generated with the fuel cell system. The voltage conversion unit converts voltage of the power charged in the capacitor to a target voltage that is set to be greater than or equal to the predetermined threshold voltage and supplies a power supply destination, which includes the motor, with power of which voltage has been converted to the target voltage.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a preferred embodiment of a forklift according to the present invention;

FIG. 2 is a block diagram of the electric structure of the forklift shown in FIG. 1 and a fuel cell unit;

FIG. 3 is a schematic front view showing a battery replaceable type fuel cell forklift;

FIG. 4A is a diagram showing the characteristics of a lead-acid battery; and

FIG. 4B is a diagram showing the characteristics of an electric double-layer capacitor.

### DETAILED DESCRIPTION OF THE PREFERRED EMBODIMENTS

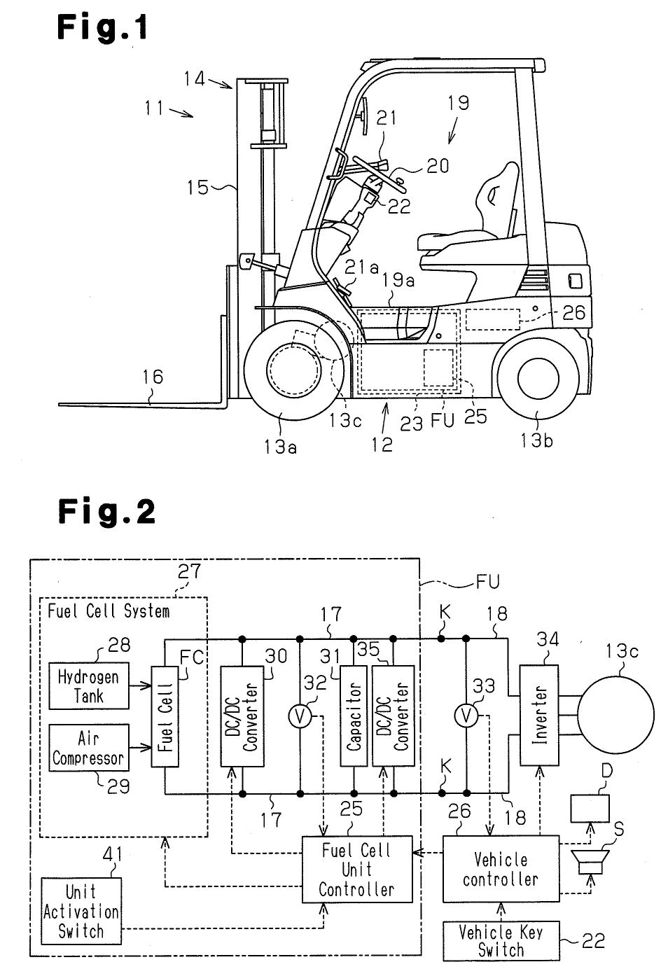

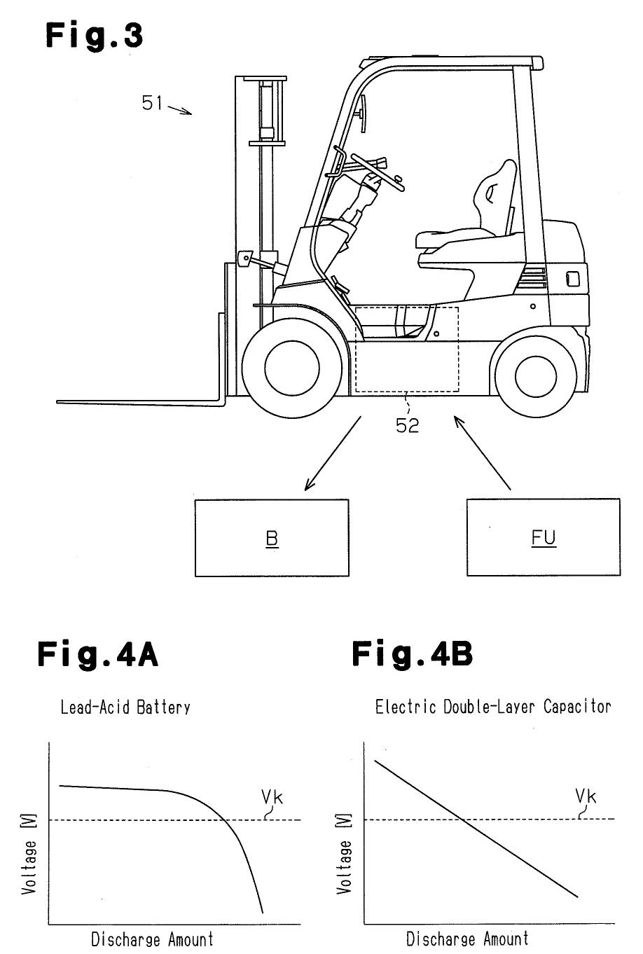

A preferred embodiment of the present invention will now be discussed with reference to FIGS. 1 to 3. In the description hereafter, the front direction (forward direction) in which the operator of the forklift would face when driving the forklift serves as the frame of reference for the directions referred to as front, rear, up, and down.

Referring to FIG. 1, a forklift 11, which serves as a fuel cell industrial vehicle, includes a body 12 and a lift apparatus 14. The lift apparatus 14 includes a mast 15 and a fork 16, which is located at the front of the body 12. Drive wheels 13a (front wheels) are mounted on the front lower part of the body 12. Steered wheels 13b (rear wheels) are mounted on the rear lower part of the body 12. The drive wheels 13a are driven by a drive motor 13c, which is arranged in the body 12. A lift motor (not shown) drives a lift pump in order to supply hydraulic oil to a lift system hydraulic pressure circuit that drives the lift apparatus 14. In the preferred embodiment, a motor-generator that functions as a generator and as a motor, which generates drive force, is employed as the drive motor 13c. The drive motor 13c, which functions as a generator, converts kinetic energy to electric energy (regenerative power) when brakes are applied to the forklift 11.

A cabin 19 is provided at the middle of the body 12. A steering wheel 20, an operation lever 21 for operating the lift apparatus 14, and a key switch 22 (vehicle starter) are arranged at the front side of the cabin 19. The key switch 22 is operable between a stop position for turning off the power and a start position for turning on the power. When the key switch 22 is located at the start position, a vehicle start signal is output to indicate that the key switch 22 is located at the start position. Referring to FIG. 2, a display D and a speaker S are arranged in the cabin 19. The display D shows the battery capacitance, the traveling speed, and the like. The speaker S issues a predetermined notification using voice, sound, or the like. A brake pedal 21a for applying brakes to the forklift 11 is arranged on the floor 19a of the cabin 19. When depressed, the brake pedal 21a outputs a brake signal.

A battery compartment 23 is provided below the floor 19a of the cabin 19. The battery compartment 23 was originally designed to accommodate a lead-acid battery B. However, in the preferred embodiment, a fuel cell unit FU is used in place of the lead-acid battery B. The battery compartment 23 includes connectors K (refer to FIG. 2), which are used to connect wires 17 (power supply path) of the fuel cell unit FU when arranged in the battery compartment 23 with wires 18 of a power circuit in the forklift 11. As shown in FIG. 2, an inverter 34 is connected to the wires 18 of the forklift 11. The inverter 34 converts direct current, which is supplied from the fuel cell unit FU via the connectors K, to alternating current, which is used to drive motors, such as the drive motor 13c. Further, a voltage sensor 33 (lead-acid battery voltmeter) is connected to the wires 18 to detect (measure) the voltage of the fuel cell unit FU (when the lead-acid battery B is used, the voltage of the lead acid battery B). The voltage sensor 33 detects the voltage of the power supplied from the fuel cell unit FU and outputs a detection signal that is in accordance with the detected voltage. Further, the voltage sensor 33 is a voltmeter designed under the assumption that the battery compartment 23 would accommodate a lead-acid battery B. Thus, the voltage sensor 33 detects voltage without determining whether the power supply connected to the connectors K is a fuel cell unit FU or a lead-acid battery B. In the preferred embodiment, the drive motor 13c, lift motor, and the like including the wires 18 serve as a power supply destination (load) supplied with power from the fuel cell unit FU.

As shown in FIGS. 1 and 2, the body 12 includes a vehicle controller 26 (vehicle control unit), which controls the driving of the forklift 11 and lift operations of the forklift 11. In the preferred embodiment, the vehicle controller 26 serves as one of the power supply destinations (load). The vehicle controller 26, which is connected to the display D and the speaker S, outputs a predetermined message or voice. Further, the vehicle controller 26 is electrically connected to the inverter 34. The vehicle controller 26 controls operation of the inverter 34 to regulate the AC voltage supplied to the drive motor 13c and control the speed of the rotation produced by the drive motor 13c. In the same manner, the vehicle controller 26 is electrically connected to a lift inverter (not shown) so that the speed of the rotation produced by a lift motor is controllable. The vehicle controller 26 is also electrically connected to the brake pedal 21a and is able to receive the brake signal.

The vehicle controller 26 executes regenerative control to recover kinetic energy as regenerative power when braking the traveling forklift 11. More specifically, when the forklift 11 is traveling at a predetermined speed or greater and the vehicle controller 26 receives the brake signal, the vehicle controller 26 controls the inverter 34 so that regenerative power, which is generated by converting kinetic energy with the drive motor 13c, is supplied to the fuel cell unit FU. Further, the vehicle controller 26 outputs a regenerative control signal indicating that the regenerative control is being executed from when the regenerative control starts to when it ends. When, a lead-acid battery B is accommodated in the battery compartment 23, the regenerative power charges the lead-acid battery B.

Further, as shown in FIG. 2, the vehicle controller 26, which is electrically connected to the voltage sensor 33, is able to receive the detection signal output from the voltage sensor 33. When the voltage detected by the voltage sensor 33 is less than a threshold voltage Vk (when the voltage does not reach the threshold voltage Vk), the vehicle controller 26 of the preferred embodiment issues a predetermined notification and restricts operations of the forklift 11. The threshold voltage Vk is a predetermined value based on a tolerable limit discharged amount of the lead-acid battery B. When discharged such that the voltage becomes less than the threshold voltage Vk, the lead-acid battery B may be adversely affected. The threshold voltage Vk is a reference value set under the assumption that the lead-acid battery B is accommodated in the battery compartment 23. The vehicle controller 26 generates a warning (notification) by controlling the display D or speaker S in the cabin 19 to issue a message indicating that “the discharge level of the lead-acid battery is high (voltage is low).” Further, the vehicle controller 26 controls the operation of the inverter 34 or lift inverter (not shown) to restrict the supply of power to the motors, such as the drive motor 13c. This restricts the driving and lifting operation of the forklift 11. To cancel the warning issued by the vehicle controller 26 and the operation restrictions imposed by the vehicle controller 26, the fuel cell unit FU must once be removed and reactivated. When the lead-acid battery B is used, the warning and operation restrictions are cancelled by charging the lead-acid battery B.

The fuel cell unit FU accommodated in the battery compartment 23 of the forklift 11 will now be discussed in detail.

Referring to FIG. 1, the fuel cell unit FU of the preferred embodiment has a shape and size enabling it to be accommodated in the battery compartment 23 of the forklift 11 in place of the lead-acid battery B. As shown in FIGS. 1 and 2, the fuel cell unit FU is accommodated in the battery compartment 23 and connected to the wires 18 via the connectors K. This supplies the drive motors 13c and the like of the forklift 11 with power. When using the fuel cell unit FU in place of the lead-acid battery B, the voltage sensor 33 and the vehicle controller 26 of the forklift 11 are not replaced. That is, when using the fuel cell unit FU in place of the lead-acid battery B, components do not have to be replaced and modifications are not necessary for the voltage sensor 33 and vehicle controller 26 although certain wires must be exchanged.

As shown in FIG. 2, the fuel cell unit FU includes a fuel cell system 27 that generates power from hydrogen and oxygen. The fuel cell system 27 includes a fuel cell, which generates power from hydrogen and oxygen, a hydrogen tank 28, which stores hydrogen and supplies hydrogen to the fuel cell FC, and an air compressor 29, which supplies the fuel cell FC with oxygen (compressed air). The fuel cell system 27 is connected to the wires 17 of the fuel cell unit FU. An electric double-layer capacitor (hereafter simply referred to as “the capacitor”) 31 is connected in parallel to the fuel cell system 27 via a DC/DC converter 30. The capacitor 31 is chargeable by power supplied from the fuel cell system 27. The DC/DC converter 30 converts power, generated by the fuel cell system 27 and having a predetermined voltage (e.g., 40 V), to a predetermined voltage (e.g., 100 V). The predetermined voltage, which is the target to which voltage is increased by the DC/DC converter 30, is set at a voltage that is suitable for charging the capacitor 31 (e.g., tolerable upper limit voltage of the capacitor 31).

A voltage sensor 32 (unit voltmeter) for detecting the voltage of the capacitor 31, or the capacitor voltage Vc, is connected to the wires 17 of the fuel cell unit FU. The voltage sensor 32 is connected in parallel to the capacitor 31. The voltage sensor 32 detects the capacitor voltage Vc and outputs a voltage detection signal in accordance with the detected capacitor voltage Vc.

A bidirectional step-up step-down DC/DC converter, or step-up step-down converter 35, is connected to the wires 17 of the fuel cell unit FU. The step-up step-down converter 35, which is connected in parallel to the capacitor 31, is supplied with (receives) the power charged in the capacitor 31.

The step-up step-down converter 35 converts the voltage of the power supplied from the capacitor 31 to a predetermined target voltage Vm and performs a power supplying operation for supplying (outputting) the power converted to the target voltage Vm to the forklift 11. The target voltage Vm is greater than or equal to the threshold voltage Vk, which is used to determine whether the discharge level of the lead-acid battery is high (voltage is low), and set within a range applicable to the forklift 11. In the preferred embodiment, the target voltage Vm is set as 80 V.

The step-up step down converter 35 converts the voltage of the regenerative power supplied from the forklift 11 to a predetermined target voltage Vg and performs a power charging operation for supplying the power converted to the target voltage Vg to the capacitor 31 in order to charge the capacitor 31. The target voltage Vg is a voltage that is suitable for charging the capacitor 31 with power (e.g., tolerable upper limit voltage of the capacitor 31) and is set as 100 V in the preferred embodiment. Accordingly, the step-up step-down converter 35 is capable of converting and supplying power in a bidirectional manner, namely, from the fuel cell unit FU to the forklift 11 and from the forklift 11 to the fuel cell unit FU.

The fuel cell unit FU of the preferred embodiment includes a unit activation switch 41 (unit activation operation member), which activates the fuel cell unit FU. The unit activation switch 41 outputs a unit activation signal when it is turned on.

A fuel cell unit controller 25, which is arranged in the fuel cell unit FU to control the operation of the fuel cell unit FU, will now be described. In the preferred embodiment, the step-up step-down converter 35 and the unit controller 25 form a voltage conversion unit.

The unit controller 25, which includes a CPU, a ROM, a RAM, and an input-output port, controls the fuel cell unit FU, which includes the fuel cell system 27. The CPU executes predetermined computations in accordance with predetermined control programs. The ROM stores control programs required for the various computations executed by the CPU. The RAM temporarily stores various types of data required to execute computations with the CPU. The input-output port is used to input and output various types of signals. The unit controller 25, which includes the input-output port, functions as a signal input unit.

The unit controller 25, which is electrically connected to the step-up step-down converter 35, executes power supply control for having the step-up step-down converter 35 perform a power supplying operation. The unit controller 25 also executes power charging control for having the step-up step-down converter 35 perform a power charging operation.

Further, the unit controller 25, which is electrically connected to the unit activation switch 41, receives the unit activation signal from the unit activation switch 41. When receiving the unit activation signal, the unit controller 25 starts various computations. The fuel cell unit FU is in an activated state when the unit controller 25 starts various computations and the fuel cell system 27 starts to generate power.

The unit controller 25 is also connected to the vehicle controller 26 by a predetermined signal line and receives the regenerative control signal from the vehicle controller 26. The signal line, which connects the unit controller 25 and vehicle controller 26, is wired when arranging the fuel cell unit FU in the forklift 11.

The operation of the forklift 11 using the fuel cell unit FU will now be discussed. The following description will center on the supplying of power from the fuel cell unit FU and the charging of the fuel cell unit FU.

When receiving the unit activation signal, the unit controller 25 starts various computations to control the fuel cell system 27 and generate power. In other words, when receiving the unit activation signal, the unit controller 25 activates the fuel cell unit FU.

When receiving the regenerative control signal from the vehicle controller 26, the unit controller 25 executes power charge control. More specifically, when receiving the regenerative control signal from the vehicle controller 26, the unit controller 25 controls the step-up step-down converter so as to convert the voltage of the regenerative power supplied from the forklift 11 to the target voltage Vg and supply the capacitor 31 with the power that has been converted to the target voltage Vg so as to charge the capacitor 31. When the unit controller 25 no longer receives the regenerative control signal from the vehicle controller 26, the unit controller 25 ends the power charge control and controls the step-up step-down converter 35 in order to restart the supply of power to the forklift 11. The regenerative power that charges the capacitor 31 is supplied to the forklift 11 via the step-up step-down converter 35 after the power charge control ends.

The power supply control executed by the unit controller 25 will now be discussed.

The unit controller 25 controls the voltage step-up step-down operation of the step-up step-down converter 35 based on the capacitor voltage Vc, which corresponds to the voltage detection signal received from the voltage sensor 32 so that the power supplied to the forklift 11 becomes equal to the target voltage Vm.

More specifically, when the capacitor voltage Vc is lower than the target voltage Vm, the unit controller 25 controls the step-up step-down converter 35 so as to increase the voltage of the power supplied from the capacitor 31 to the target voltage Vm and then supply the power to the forklift 11. When the capacitor voltage Vc is higher than the target voltage Vm, the unit controller 25 controls the step-up step-down converter 35 so as to decrease the voltage of the power supplied from the capacitor 31 to the target voltage Vm and then supply the power to the forklift 11. Further, when the capacitor voltage Vc is equal to the target voltage Vm, the unit controller 25 controls the step-up step-down converter 35 so as to directly supply the forklift 11 with the power supplied from the capacitor 31 without converting the voltage.

As an example, it is assumed that the capacitor voltage Vc is 60 V due to self-discharge when the fuel cell unit FU is activated. In such a case, the capacitor voltage Vc detected by the voltage sensor 32 is less than the target voltage Vm (80 V). Thus, the unit controller 25 controls the step-up step-down converter 35 so as to increase the capacitor voltage Vc to the target voltage Vm and supply the forklift 11 with the power that has been increased to the target voltage Vm. As a result, the power supplied to the forklift 11 becomes 80 V, the voltage of which is greater than or equal to the threshold value Vk, and the vehicle controller 26 does not determine that “the discharge level of the lead-acid battery is high (voltage is low).” If a state in which the capacitor voltage Vc is less than the target voltage Vm continues, the unit controller 25 continues the control for increasing voltage with the step-up step-down converter 35.

Then, as the power supplied from the fuel cell system 27 charges the capacitor 31 and the capacitor voltage Vc becomes equal to the target voltage Vm, the vehicle controller 26 controls the step-up step-down converter 35 so as to directly supply the forklift 11 with the power supplied from the capacitor 31 without converting the voltage. Further, as the power supplied from the fuel cell system 27 charges the capacitor 31 and the capacitor voltage Vc becomes greater than the target voltage Vm, the vehicle controller 26 controls the step-up step-down converter 35 so as to decrease the capacitor voltage Vc to the target voltage Vm and supply the forklift 11 with the power that has been decreased to the target voltage Vm.

In this manner, the voltage of the power supplied to the forklift 11 from the capacitor 31 via the step-up step-down converter 35 is held at the target voltage Vm regardless of the capacitor voltage Vc. In other words, the fuel cell unit FU does not supply the forklift 11 with power having a voltage that is lower than the threshold voltage Vk.

The operation of the vehicle controller 26 for the forklift 11 when supplied with power from the fuel cell unit FU will now be described.

When the vehicle start signal is received from the key switch 22, the vehicle controller 26, which is supplied with power from the fuel cell unit FU, starts vehicle control to monitor the voltage detected by the voltage sensor 33 and control the inverter 34. As described above, the voltage of the power supplied from the fuel cell unit FU is held at the target voltage Vm from immediately after the fuel cell unit FU is activated. Thus, the vehicle controller 26 does not determine that “the discharge level of the lead-acid battery is high (voltage is low).”

The preferred embodiment has the advantages described below.

(1) The power supplied from the capacitor (i.e., power that charges the capacitor 31) is converted to the target voltage Vm by the step-up step-down converter 35 and then supplied to the drive motor 13c and the like in the forklift 11. In this state, the unit controller 25 controls the step-up step-down converter 35 so as to increase the capacitor voltage Vc if it is lower than the target voltage Vm and decrease the capacitor voltage Vc if it is higher than the target voltage Vm. Accordingly, the voltage of the power supplied to the forklift 11 is held at the target voltage Vm. In the preferred embodiment, the target voltage Vm is set at a voltage that is greater than or equal to the threshold voltage Vk. Thus, the voltage of the power supplied to the forklift 11 is constantly greater than or equal to the threshold voltage Vk. Thus, in a state in which the capacitor voltage Vc is less than the predetermined threshold voltage Vk, by supplying the forklift 11 with power and starting vehicle control with the vehicle controller 26, the issuance of predetermined warnings and the operation restrictions in the forklift 11 are avoided. Thus, even when using the fuel cell unit FU in place of the lead-acid battery B, the voltage sensor 33 and vehicle controller 26 may be continuously used. Further, the vehicle controller 26 does not restrict operation of the forklift 11.

(2) The fuel cell unit FU includes the unit activation switch 41. When the activation switch 41 is turned on, the activation switch 41 outputs the unit activation signal that activates the fuel cell unit FU. Thus, when the forklift 11 uses the fuel cell unit FU, there is no need to perform wiring for controlling the activation of the fuel cell unit FU such as the connection of a signal line between the key switch 22 and the unit controller 25. Accordingly, replacement of the lead-acid battery B with the fuel cell unit FU is simple.

(3) A typical power generation cell for the fuel cell unit FC is costly. In the preferred embodiment, the voltage of the power supplied to the forklift 11 is held at the target voltage Vm by increasing or decreasing the voltage of the power supplied from the capacitor 31 with the step-up step-down converter 35. This keeps the amount of power generated by the fuel cell system 27 low. Thus, the scale of a power generation system in the fuel cell unit FC may be reduced and costs may be saved.

(4) The unit controller 25 controls the step-up step-down converter 35 so as to charge the capacitor 31 of the fuel cell unit FU with regenerative power. Thus, the kinetic energy of the forklift 11 during braking is recovered as regenerative power (energy), and the regenerative power is used to drive the forklift 11 and perform lift operations with the forklift 11.

It should be apparent to those skilled in the art that the present invention may be embodied in many other specific forms without departing from the spirit or scope of the invention. Particularly, it should be understood that the present invention may be embodied in the following forms.

When the vehicle controller 26 determines that “the discharge level of the lead-acid battery is high (voltage is low),” the vehicle controller 26 may perform only one of issuing a warning on the display D and issuing a voice warning from the speaker S. Further, the vehicle controller 26 does not have to issue both of a warning on the display D and a voice warning from the speaker S.

The unit controller 25 and the key switch 22 may be connected by a signal line and the unit controller 25 and the vehicle controller 26 may be connected by a signal line so that the vehicle start signal output from the key switch 22 is input to the vehicle controller 26 via the unit controller 25. Further, the vehicle controller 26 and the unit controller 25 may both be connected to the key switch 22 by signal lines so that the vehicle start signal is directly input to both of the vehicle controller 26 and unit controller 25. Such a structure would enable activation of the fuel cell unit FU and the vehicle controller 26 just by operating the key switch 22 and simplify activation of the entire forklift 11. In this case, the unit controller 25 includes an input-output port for receiving the vehicle start signal and serves as a signal input unit.

When the vehicle controller 26 determines that “the discharge level of the lead-acid battery is high (voltage is low),” the vehicle controller 26 may prohibit driving and lift operations of the forklift 11. Further, the operations of the forklift 11 may be restricted in a stepped manner in accordance with the voltage detected by the voltage sensor 33.

The unit controller 25 does not have to execute power charge control. In this case, the step-up step down converter 35 does not have to perform bidirectional voltage conversion and supply the converted voltage. Further, the unit controller 25 does not need to be wired to enable input of the regenerative control signal from the vehicle controller. Such a structure would also hold the voltage of the power supplied from the fuel cell unit FU to the forklift 11 at the target voltage Vm. Additionally, the vehicle controller 26 would not give a determination that “the discharge level of the lead-acid battery is high (voltage is low)” and therefore would not issue a predetermined warning (notification) or restrict operation of the forklift 11. Moreover, wiring for the input of the regenerative control signal would not be necessary, and the replacement of the lead-acid battery B would be further simple.

A normal drive motor may be used as the drive motor 13c, and a generator that generates regenerative power from the kinetic energy of the forklift 11 during braking may be separately provided.

The forklift 11 does not have to use the drive motor 13c as a generator and does not have to recover the kinetic energy of the forklift 11 during braking as regenerative power.

The forklift 11 may use the lift motor as a generator and recover, for example, kinetic energy of a load held on the fork 16 when lowering the fork 16.

The fuel cell unit FU may include a fuel cell system that generates power using a fuel other than hydrogen, such as methanol and natural gas.

The present invention is embodied in the forklift but may be embodied in other types of vehicles (industrial vehicle).

The present examples and embodiments are to be considered as illustrative and not restrictive, and the invention is not to be limited to the details given herein, but may be modified within the scope and equivalence of the appended claims.

What is claimed is:

1. An industrial vehicle optionally powerable by a lead-acid battery, the industrial vehicle comprising:
a fuel cell unit;
a motor which generates drive force when supplied with power from the fuel cell unit or the lead-acid battery;
a voltmeter which measures voltage of the fuel cell unit or voltage of the lead-acid battery; and
a vehicle control unit which controls operation of the industrial vehicle and restricts operation of the industrial vehicle when the voltage measured by the voltmeter is less than a predetermined threshold voltage;
wherein the fuel cell unit includes:
a capacitor which is chargeable by power generated with the fuel cell system; and
a voltage conversion unit which converts voltage of the power charged in the capacitor to a target voltage that is set to be greater than or equal to the predetermined threshold voltage and supplies a power supply destination, which includes the motor, with power of which voltage has been converted to the target voltage.

2. The industrial vehicle according to claim 1, wherein:
the fuel cell unit further includes a unit voltmeter which detects voltage of the capacitor; and
the voltage conversion unit increases the capacitor voltage to the target voltage when the capacitor voltage is lower than the target voltage and decreases the capacitor voltage to the target voltage when the capacitor voltage is higher than the target voltage to hold the voltage of the power supplied to the power supply destination at the target voltage.

3. The industrial vehicle according to claim 1, further comprising:
a vehicle start member which when operated to start the industrial vehicle sends a vehicle start signal to the vehicle control unit in order to start the industrial vehicle;
wherein the fuel cell unit further includes:
a unit activation operation member which when operated to activate the fuel cell unit outputs a unit activation signal, the unit activation operation member being discrete from the vehicle start member; and
a signal input unit which receives the unit activation signal; and
wherein the fuel cell unit is activated when receiving the unit activation signal.

4. The industrial vehicle according to claim 1, further comprising:
a vehicle start member which when operated to start the industrial vehicle outputs a vehicle start signal;
wherein the fuel cell unit further includes a signal input unit, which receives the vehicle start signal, and is activated when receiving the vehicle start signal.
